(19) United States
(12) Patent Application Publication
(10) Pub. No.: US 2023/0283570 A1
(43) Pub. Date: Sep. 7, 2023

(54) RESOURCE ALLOCATION APPARATUS AND ALLOCATING RESOURCE METHOD

(71) Applicant: Fujitsu Limited, Kawasaki-shi (JP)

(72) Inventors: Hiromasa Yamauchi, Kawasaki (JP); Keiichi Nakatsugawa, Shinagawa (JP); Makoto Kubota, Kawasaki (JP)

(73) Assignee: Fujitsu Limited, Kawasaki-shi (JP)

(21) Appl. No.: 18/083,755

(22) Filed: Dec. 19, 2022

(30) Foreign Application Priority Data
Mar. 4, 2022 (JP) 2022-033842

(51) Int. Cl. H04L 47/78; H04L 41/0893; H04L 43/026

(52) U.S. Cl. CPC H04L 47/781; H04L 41/0893; H04L 43/026

(57) ABSTRACT

A resource allocation apparatus includes a memory, and a processor coupled to the memory and configured to select, based on template information of each of a plurality of containers to be deployed, from among the containers, a first candidate container to be deployed to an information processing apparatus of a first cluster coupled to a second cluster via an external network, determine, based on flow information of communication between the containers, whether a communication band in a case where the selected container is deployed to a gateway of the second cluster coupled to the external network satisfies traffic of a second candidate container to be deployed to an information processing apparatus of the second cluster, and determine a deployment destination of each container, based on a result of the determination of whether the communication band satisfies the traffic.

### CROSS-REFERENCE TO RELATED APPLICATION

This application is based upon and claims the benefit of priority of the prior Japanese Patent Application No. 2022-33842, filed on Mar. 4, 2022, the entire contents of which are incorporated herein by reference.

### FIELD

The embodiments discussed herein is related to a resource allocation apparatus and an allocating a resource method.

### BACKGROUND

In recent years, a container virtualization technique that loads (deploys), for operation, programs included in a process to resources such as server devices on a container-by-container basis has been widely used. The container virtualization technique is applied to a system in which, for example, a plurality of programs are distributed and deployed to a plurality of resources.

In order to facilitate a setup of such a system, there is a tool that automates deployment (allocation) to resources that are to serve as deployment destination of the containers. The allocation of each container to the resource with this tool is performed based on system information defined by a system administrator and an application template defined by an application developer.

FIG. 23 is an explanatory diagram explaining an example of the application template. As illustrated in FIG. 23, system information 300 includes information such as a system configuration of each node in a cluster. An application template 301 includes container information 311 and flow information 312.

The container information 311 is information on each container in an application. The container information 311 includes a resource size desired for each container, a deployment destination node (in a case where the deployment destination is fixed), a deployable central processing unit (CPU) architecture, and the like. Since deployment destinations are designated as “Node 1” for “Container 1” and “Node 4” for “Container 4” in the container information 311 in the illustrated example, the deployment destinations of “Container 2” and “Container 3” are to be determined.

The flow information 312 is information on a flow in an application (excusable delay between flows is described when definable) and a sub-flow between the containers (a communication method, a bandwidth, and so forth). In allocating each container, based on the system information 300 and the application template 301 described above, a deployment destination of the container is determined in accordance with a container deployment algorithm, a manifest file is generated, and the deployment of the container is executed based on the generated manifest file.

FIG. 24 is an explanatory diagram explaining a container deployment algorithm of related art. As illustrated in FIG. 24, with the container deployment algorithm of related art, a server apparatus or the like that allocates resources (hereafter referred to as a resource allocation apparatus) generates, regarding each container in the application template 301, a plurality of container division patterns P300 by changing the number of containers in groups. For example, a container division pattern P301 is a division pattern in a case where the number of containers in a group is four. A container division pattern P302 is a division pattern in a case where the number of containers in the groups is two. A container division pattern P303 is a division pattern in a case where the number of containers in the groups is one.

Next, based on the flow between the containers and the resource size desired for each container, the resource allocation apparatus of related art sets the priority (priority rank) of each of the container division patterns P300. For example, in the container division pattern P302, the priority rank of “xx” is set for “Container group 1” and the priority rank of “yy” is set for “Container group 2”.

Next, the resource allocation apparatus of related art sets the priority indicating from which node in a cluster a container is to be deployed. In the illustrated example, the priority rank of “xx” is set for the node N1, the priority rank of “yy” is set for the nodes N2 and N3, and the priority rank of “zz” is set for the nodes N4 and N5.

For each of the container division patterns P300, the resource allocation apparatus of related art determines whether the container is able to be deployed (satisfies a resource requisite) in order of the set priority from a node assigned with a higher priority.

Japanese National Publication of International Patent Application Nos. 2015-534663 and 2015-515037 are disclosed as related art.

### SUMMARY

According to an aspect of the embodiments, a resource allocation apparatus includes a memory, and a processor coupled to the memory and configured to select, based on template information of each of a plurality of containers to be deployed, from among the containers, a first candidate container to be deployed to an information processing apparatus of a first cluster coupled to a second cluster via an external network, determine, based on flow information of communication between the containers, whether a communication band in a case where the selected container is deployed to a gateway of the second cluster coupled to the external network satisfies traffic of a second candidate container to be deployed to an information processing apparatus of the second cluster, and determine a deployment destination of each container, based on a result of the determination of whether the communication band satisfies the traffic.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram explaining resource allocation according to embodiments;

FIG. 2 is an explanatory diagram explaining an example of a deployment destination search;

FIG. 3 is an explanatory diagram explaining an example of container selection;

FIG. 4 is an explanatory diagram explaining the example of the container selection;

FIG. 5 is an explanatory diagram explaining the example of the container selection;

FIG. 6 is an explanatory diagram explaining an example of band determination;

FIG. 7 is an explanatory diagram explaining the example of the band determination;

FIG. 8 is an explanatory diagram explaining the example of the band determination;

FIG. 9 is an explanatory diagram exemplifying a search for a deployment destination to an other cluster;

FIG. 10 is an explanatory diagram exemplifying the search for the deployment destination to the other cluster;

FIG. 11 is an explanatory diagram exemplifying determination of the deployment destination of the container;

FIG. 12 is a block diagram explaining an example of the functional configurations of a resource allocation apparatus according to the embodiments;

FIGS. 13A and 13B are flowcharts illustrating an example of operation of the resource allocation apparatus according to the embodiments;

FIG. 14 is a flowchart illustrating an example of operation of deployment pattern generation and intra-cluster deployment search;

FIG. 15 is a flowchart illustrating an example of operation of reordering of deployment patterns;

FIGS. 16A and 16B are flowcharts illustrating an example of operation of reordering of containers;

FIG. 17 is a flowchart illustrating an example of operation of reordering of nodes;

FIG. 18 is a flowchart illustrating an example of operation of the deployment destination search;

FIG. 19 is a flowchart illustrating an example of operation of container deployment pattern priority setting;

FIG. 20 is a flowchart illustrating an example of operation of container deployment pattern priority setting (1);

FIG. 21 is a flowchart illustrating an example of operation of container deployment pattern priority setting (2);

FIG. 22 is an explanatory diagram explaining an example of the configuration of a computer;

FIG. 23 is an explanatory diagram explaining an example of an application template;

FIG. 24 is an explanatory diagram explaining a container deployment algorithm of related art; and

FIG. 25 is an explanatory diagram explaining an increase in the number of combinations of the deployment candidates.

### DESCRIPTION OF EMBODIMENTS

With the related art, in a case where the containers are deployed over a plurality of clusters, the deployment destination of each container is searched from the nodes in the plurality of clusters. This causes a problem in that the number of combinations of deployment candidates increases as the number of nodes increases.

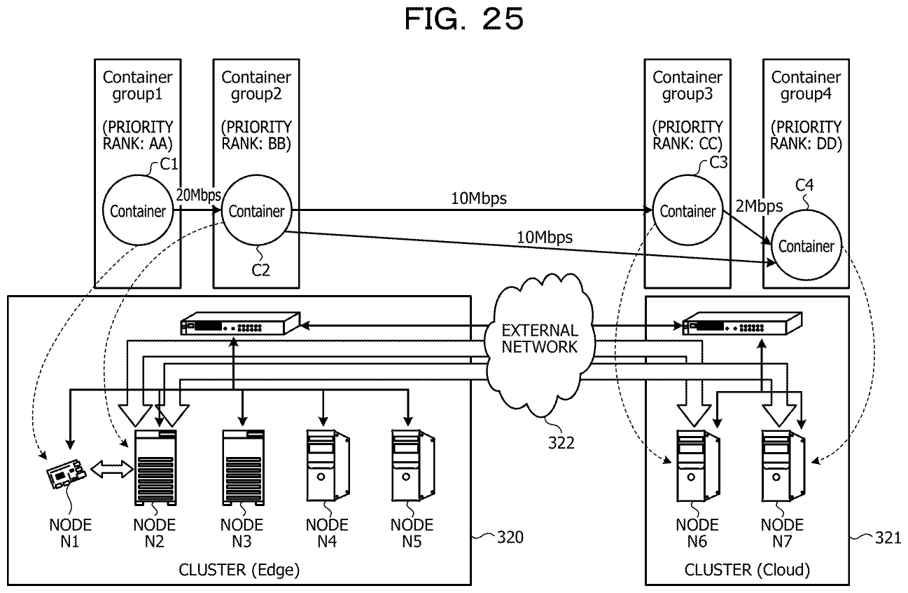

FIG. 25 is an explanatory diagram explaining the increase in the number of combinations of the deployment candidates. As illustrated in FIG. 25, as is the case with a cluster (Edge) 320 and a cluster (Cloud) 321 which are coupled to each other via an external network 322, a system may be built with a plurality of clusters in some cases. Since the containers are deployed over a plurality of clusters in such a system, the nodes N6 and N7 of the cluster (Cloud) 321 also serve as deployment destination candidates in addition to the nodes N1 to N5 of the cluster (Edge) 320. Thus, the number of combinations of search targets increases. When the number of combinations of the search targets increases as described above, man-hours regarding the resource allocation increase, and accordingly, it becomes difficult to find appropriate container allocation.

Hereinafter, with reference to the drawings embodiments of techniques capable to assist in executing resource allocation over a plurality of clusters are described. In the embodiments, elements having the same functions are denoted by the same reference numerals, thereby redundant description thereof is omitted. The techniques described in the following embodiments are merely exemplary and are not intended to limit the embodiments. Portions of the embodiments below may be appropriately combined as long as the portions of the embodiments do not contradict each other.

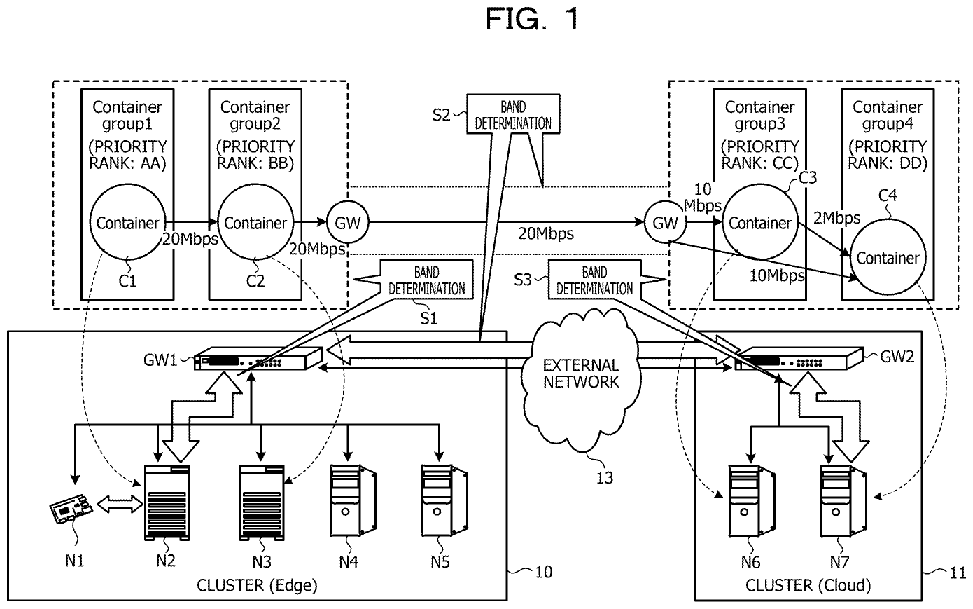

FIG. 1 is an explanatory diagram explaining resource allocation according to the embodiments. As illustrated in FIG. 1, the resource allocation apparatus according to the embodiments deploys programs included in a process in units of containers C1 to C4 to the nodes (nodes N1 to N7 in the illustrated example).

The resource allocation apparatus according to the embodiments may use Kubernetes (hereafter, referred to as K8s) as a container management tool. In this case, the resource allocation apparatus according to the embodiments manages one or a plurality of containers in a minimum execution unit of the K8s unit called Pod. For example, Pods including one or a plurality of containers are each executed in the individual nodes (N1 to N7). In the resource allocation apparatus according to the embodiments, it is assumed that information related to container deployment (for example, the system information 300, the application template 301, the container information 311, and the flow information 312) has been set by a user or the like in the above-described container management tool.

As the resource allocation apparatus according to the embodiments, for example, a server apparatus or the like may be applied. For example, the resource allocation apparatus according to the embodiments determines the deployment destination of each of the nodes N1 to N7 based on information related to the container deployment, generates a manifest file, and executes the container deployment based on the generated manifest file.

Each of the nodes including, for example, nodes N1 to N7 herein is an information processing apparatus (a personal computer (PC), a graphics processing unit (GPU), a server device, or the like) that provides an environment in which the program included in the process is operated on a container-by-container basis. Each of the nodes including, for example, the nodes N1 to N7 may be referred to as a worker in the following description in some cases.

The nodes N1 to N7 are included in a plurality of clusters communicably coupled to each other via an external network 13 such as a local area network (LAN) or the Internet. For example, the nodes N1 to N5 are included in a cluster (Edge) 10. The nodes N6 to N7 are included in a cluster (Cloud) 11. The cluster (Edge) 10 is coupled to the external network 13 via a gateway GW1, and the cluster (Cloud) 11 is coupled to the external network 13 via a gateway GW2.

According to the present embodiments, attention is paid to traffic between the containers in a case where the containers are deployed over the cluster (Edge) 10 and the cluster (Cloud) 11 at the time of resource allocation.

For example, the traffic flows to a container deployed to an other cluster (for example, the cluster (Cloud) 11) with respect to an own cluster (for example, the cluster (Edge) 10) via a gateway (the gateway GW1) coupled to the external network 13 of the own cluster regardless of how the container in the other cluster is deployed to the worker in the cluster. Thus, according to the present embodiments, attention is paid to the fact that, in a communication path in the own cluster, the container deployed to a node of the other cluster is on the same path as that in the case where the deployment destination of this container is the gateway of the own cluster. For example, with respect to the container deployed to the node of the other cluster, in whichever node this container is deployed to the other cluster, the communication path in the own cluster is the same path as the gateway of the own cluster.

The resource allocation apparatus according to the embodiments performs band determination (S1 to S3) on the container the deployment destination of which is the other cluster to determine whether a communication band in a case where the deployment destination of this container is the gateway of the own cluster satisfies traffic of a candidate container to be deployed to the own cluster. Thus, at the time of a deployment pattern search for searching a node to which a container is to be deployed, with respect to the container the deployment destination of which is the other cluster, the resource allocation apparatus according to the embodiments performs replacement with the deployment pattern search in each cluster by using the above-described band determination.

Accordingly, with the resource allocation apparatus according to the embodiments, since the number of the workers as deployment candidates is limited (independently of the number of nodes in the other clusters), an increase in the number of combinations of the workers that are the deployment candidates may be suppressed even in a case where the containers C1 to C4 are deployed over a plurality of clusters.

For example, the resource allocation apparatus according to the embodiments searches a worker that satisfies a computing resource requisite and a network resource requisite of the containers C1 to C4 in a default cluster (for example, the cluster (Edge) 10).

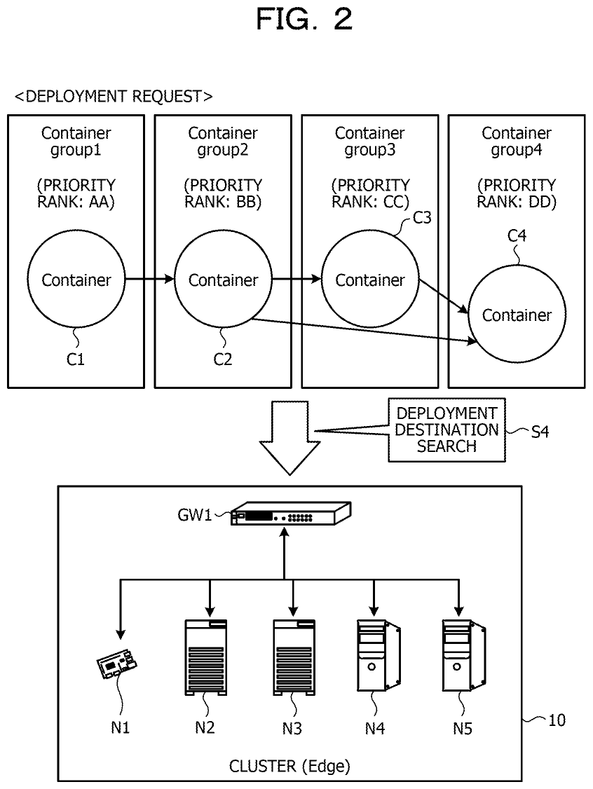

FIG. 2 is an explanatory diagram explaining an example of a deployment destination search. As illustrated in FIG. 2, the resource allocation apparatus according to the embodiments reads container information in order of a priority rank set at the time of a deployment request or the like for the containers C1 to C4 for which the deployment request has been made.

Next, for the read containers, the resource allocation apparatus according to the embodiments searches the workers that satisfy the computing resource requisite (nodes N1 to N5 in the illustrated example) based on the system information in the default cluster (cluster (Edge) 10 in the illustrated example). Next, the resource allocation apparatus according to the embodiments determines whether the communication band between the deployment destination workers satisfies the network resource requisite. The resource allocation apparatus according to the embodiments performs the deployment destination search in the cluster (Edge) 10 by performing the above-described processing for all of the containers C1 to C4 (S4).

Next, in a case where not all the containers are able to be deployed to the default cluster, the resource allocation apparatus according to the embodiments selects candidate containers to be deployed to an other cluster (for example, cluster (Cloud) 11).

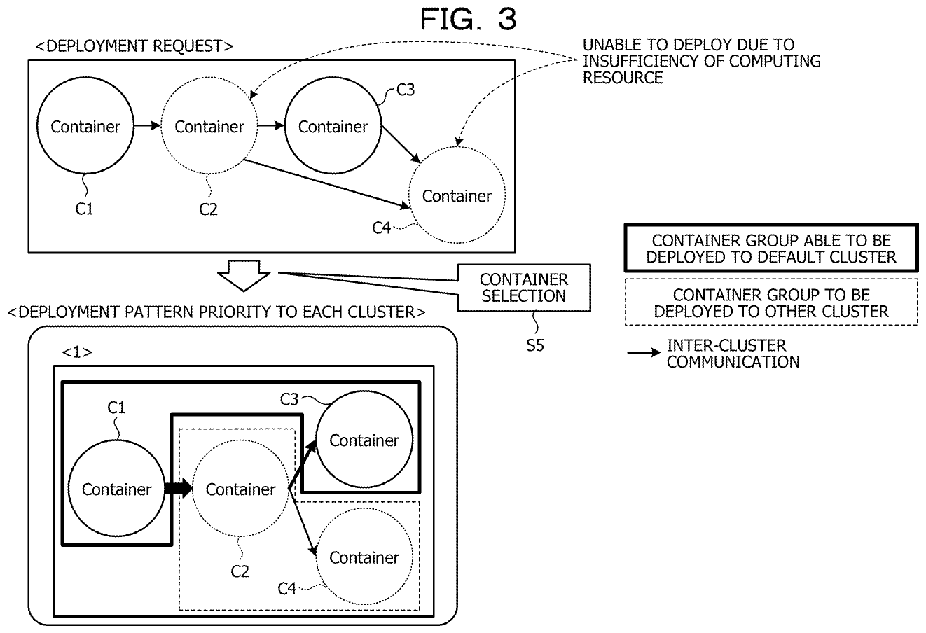

FIGS. 3 to 5 are explanatory diagrams explaining an example of container selection. As illustrated in FIG. 3, in a case where not all the containers C1 to C4 are able to be deployed to the cluster (Edge) 10 due to an insufficiency of a computing resource such as central processing unit (CPU) performance or memory capacity, the resource allocation apparatus according to the embodiments selects containers to be deployed to the cluster (Cloud) 11. For example, it is assumed that the containers C2 and C4 are not able to be deployed to the cluster (Edge) 10 due to the insufficiency of the computing resource. In this case, the resource allocation apparatus according to the embodiments generates a deployment pattern to deploy, to the cluster (Edge) 10, the containers C1 and C3 able to be deployed and, to the cluster (Cloud) 11, the containers C2 and C4 determined not to be deployed.

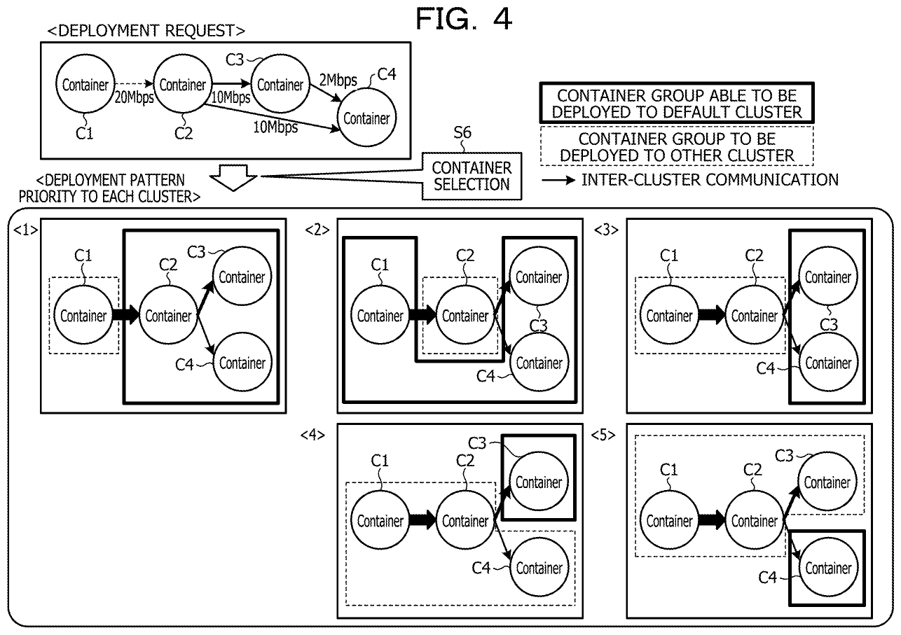

As illustrated in FIG. 4, in a case where subflows (inter-container communications) causing insufficiency of the network resource exist, the resource allocation apparatus according to the embodiments may select containers to be deployed to the other cluster based on the subflows. For example, the resource allocation apparatus according to the embodiments selects a container at either of the ends of a target subflow as a container to be deployed to the other cluster. Alternatively, the resource allocation apparatus according to the embodiments selects the containers at both the ends of the target subflow as the containers to be deployed to the other cluster.

As in the illustrated example, when the subflow causing the insufficiency of the network resource exists between the containers C1 and C2, the resource allocation apparatus according to the embodiments cuts out one of the containers C1 and C2 and generates container groups (<1>, <2>) to be deployed to the other cluster. Alternatively, the resource allocation apparatus according to the embodiments generates container groups (<3>, <4>, <5>) to deploy both the containers C1 and C2 to the other cluster.

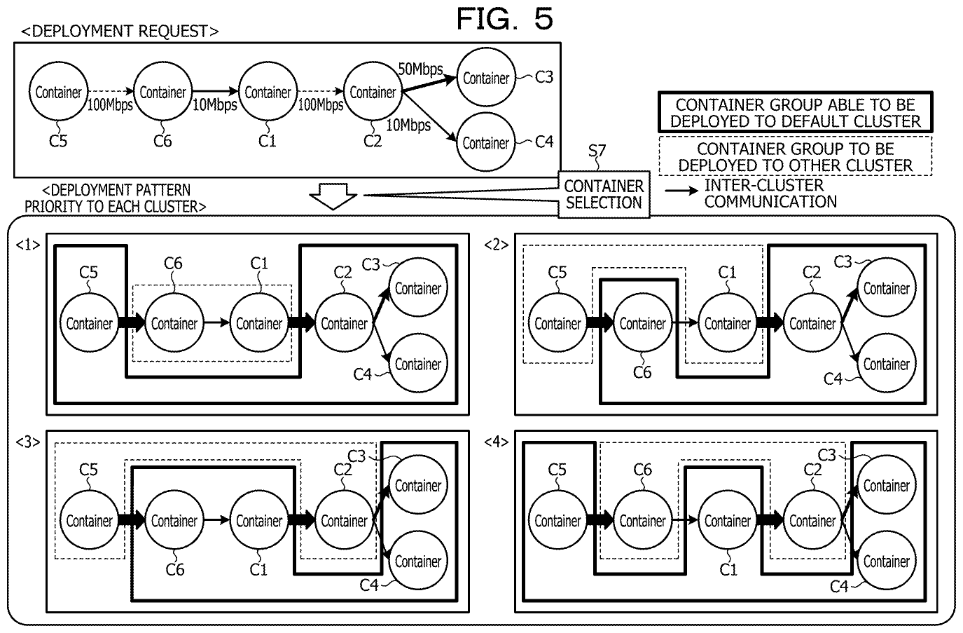

As illustrated in FIG. 5, also in a case where a plurality of subflows (inter-container communications) causing the insufficiency of the network resource exist, the resource allocation apparatus according to the embodiments selects the container to be deployed to the other cluster based on these subflows as is the case with the example illustrated in FIG. 4.

As in the illustrated example, it is assumed that subflows causing the insufficiency of the network resource exist between the containers C1 and C2 and between the containers C5 and C6. In such a case, the resource allocation apparatus according to the embodiments may generate container groups (<1> to <4>) to deploy one of the containers C1 and C2 or one of the containers C5 and C6 to the other cluster. Alternatively, the resource allocation apparatus according to the embodiments may generate container groups to deploy both of the containers C1 and C2 or both of the containers C5 and C6 to the other cluster.

Referring back to FIG. 1, next, the resource allocation apparatus according to the embodiments performs the band determination (S1) on whether the communication band in the default cluster satisfies the traffic of the containers to be deployed in the default cluster on the assumption that the deployment destination of the candidate container to be deployed to the other cluster is the gateway (for example, the gateway GW1) coupled to the external network 13.

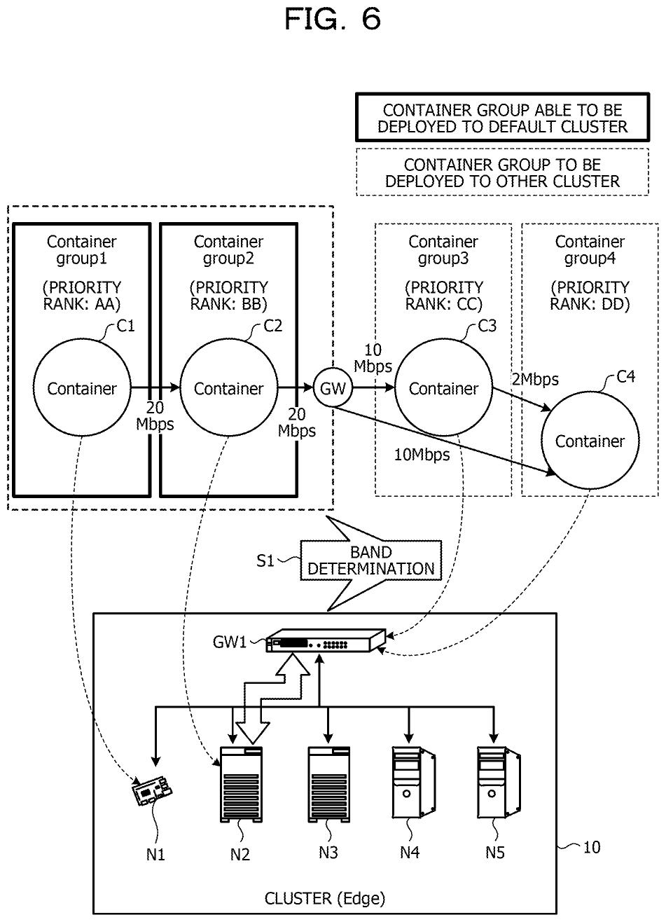

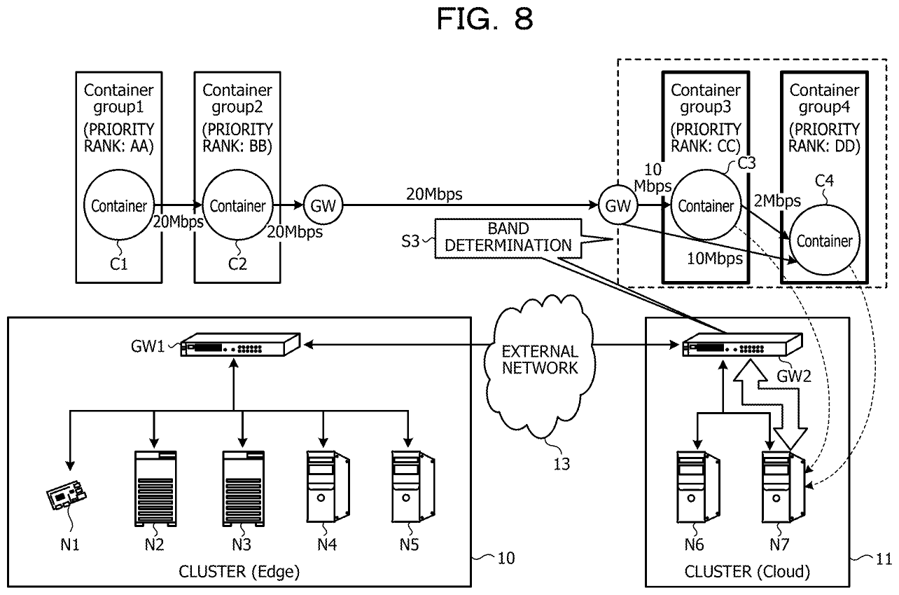

FIGS. 6 to 8 are explanatory diagrams explaining examples of the band determination. As illustrated in FIG. 6, the resource allocation apparatus according to the embodiments assumes that the deployment destinations of the containers C3 and C4 which are candidates to be deployed to the other cluster is the gateway GW1 coupled to the external network 13. Next, based on the system information 300, the resource allocation apparatus according to the embodiments determines whether the traffic of the candidate containers C1 and C2 to be deployed to the cluster (Edge) 10 and the candidate containers C3 and C4 assumed to be the gateway GW1 satisfies the communication band of the gateway GW1.

In the configuration of the example illustrated in FIG. 6, the candidate container C2 to be deployed to the cluster (Edge) 10 and the candidate containers C3 and C4 assumed as the gateway GW1 communicate with each other, and each of the traffic between the containers C2 and C3 and the traffic between the containers C2 and C4 is 10 Mbps (total 20 Mbps). When it is assumed that the communication band of the gateway GW1 is 20 Mbps, the resource allocation apparatus according to the embodiments determines that the above-described traffic satisfies the communication band of the gateway GW1.

In a case where the communication band of the gateway GW1 is 10 Mbps, the resource allocation apparatus according to the embodiments determines that the above-described traffic does not satisfy the communication band of the gateway GW1.

As described above, even in a case where the deployment candidates of the containers C3 and C4 are the other cluster, the resource allocation apparatus according to the embodiments may verify whether the containers C3 and C4 are able to be deployed regardless of the number of workers in the other cluster. Thus, the resource allocation apparatus according to the embodiments may suppress the increase in the number of combinations of the workers that are the deployment candidates.

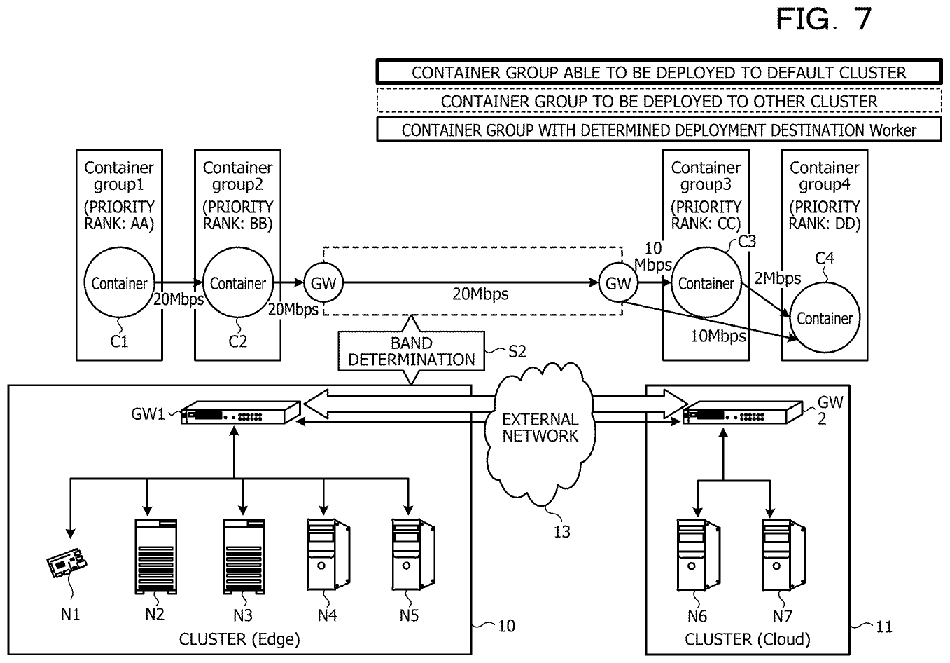

As illustrated in FIG. 7, the resource allocation apparatus according to the embodiments may set a cluster priority of each of the clusters (the cluster (Edge) 10, the cluster (Cloud) 11, and so forth) and identify the cluster that is the candidate for the deployment destination in accordance with the order of the cluster priority. For example, in a case where the cluster priority is set to increase in order of the cluster (Edge) 10, the cluster (Cloud) 11, and so forth, the resource allocation apparatus according to the embodiments first searches the deployment destinations of the containers C1 to C4 from among the nodes N1 to N5 of the cluster (Edge) 10.

It is assumed that the cluster priority of each cluster is set in advance by the user based on a usage fee of virtual machines (VM), a usage fee of a network, or the like.

Next, in a case where not all the containers C1 to C4 are able to be deployed to the nodes N1 to N5 of the cluster (Edge) 10 by this search, the resource allocation apparatus according to the embodiments identifies the cluster (Cloud) 11 assigned with the next highest cluster priority in accordance with the order of the cluster priority. For example, in a case where the containers C1 and C2 are able to be deployed to the cluster (Edge) 10, the resource allocation apparatus according to the embodiments identifies the cluster (Cloud) 11 as the candidate for the deployment destinations of the containers C3 and C4 based on the cluster priority.

Next, the resource allocation apparatus according to the embodiments performs the band determination between the gateway GW1 of the cluster (Edge) 10 that is the candidate for the deployment destinations of the containers C1 and C2 and the gateway GW2 of the cluster (Cloud) 11 that is the candidate for the deployment destinations of the containers C3 and C4 (S2). For example, based on the system information 300, the resource allocation apparatus according to the embodiments determines whether the communication band between the gateway GW1 of the cluster (Edge) 10 and the gateway GW2 of the cluster (Cloud) 11 satisfies the traffic between the containers (between the container C1, C2 and the container C3, C4).

In the configuration of the example illustrated in FIG. 7, the candidate container C2 to be deployed to the cluster (Edge) 10 and the containers C3 and C4 communicate with each other, and each of the traffic between the containers C2 and C3 and the traffic between the containers C2 and C4 is 10 Mbps (total 20 Mbps). When it is assumed that the communication band between the gateways GW1 and GW2 is 20 Mbps, the resource allocation apparatus according to the embodiments determines that the above-described traffic satisfies the communication band of the gateway GW1.

As described above, the resource allocation apparatus according to the embodiments checks whether the network resource between the cluster (Edge) 10 and the cluster (Cloud) 11 that are candidates for the deployment destinations of the containers C1 to C4 satisfies the traffic between the containers. In a case where the network resource between the cluster (Edge) 10 and the cluster (Cloud) 11 does not satisfy the traffic between the containers, the resource allocation apparatus according to the embodiments identifies a cluster assigned with the next highest cluster priority.

In a case where the network resource between the cluster (Edge) 10 and the cluster (Cloud) 11 satisfies the traffic between the containers, the resource allocation apparatus according to the embodiments assumes, in contrast to S1, the deployment destinations of the containers C1 and C2 to be deployed to the cluster (Edge) 10 are the gateway GW2 of the cluster (Cloud) 11. Next, the resource allocation apparatus according to the embodiments performs the band determination (S3) on whether the communication band in the cluster (Cloud) 11 satisfies the traffic of the containers C3 and C4 to be deployed in the cluster (Cloud) 11.

In a case where there remains a container for which no worker that satisfies the band determination (S3) exists, the resource allocation apparatus according to the embodiments returns to the processing in S2 for only this container.

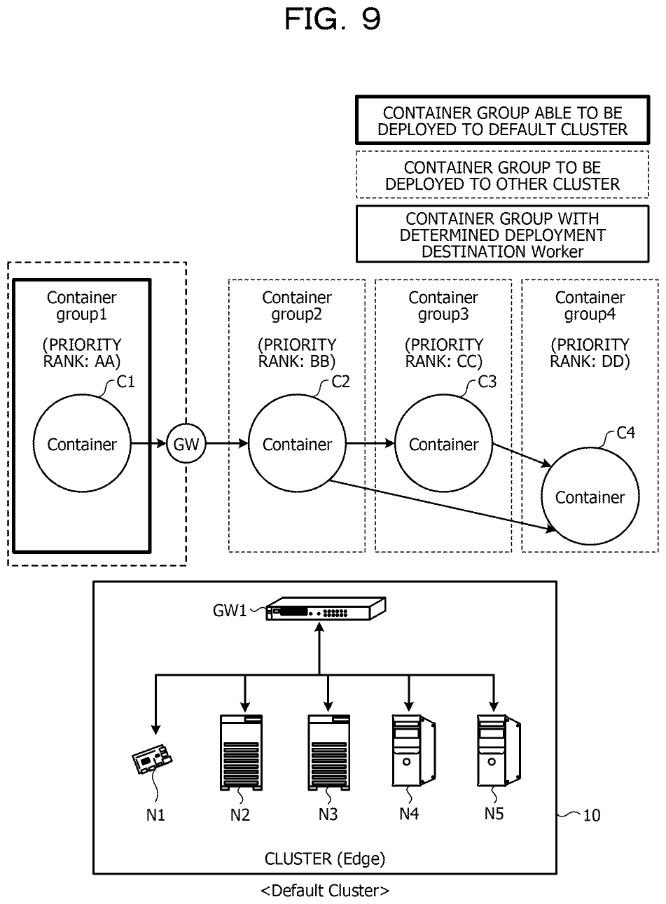

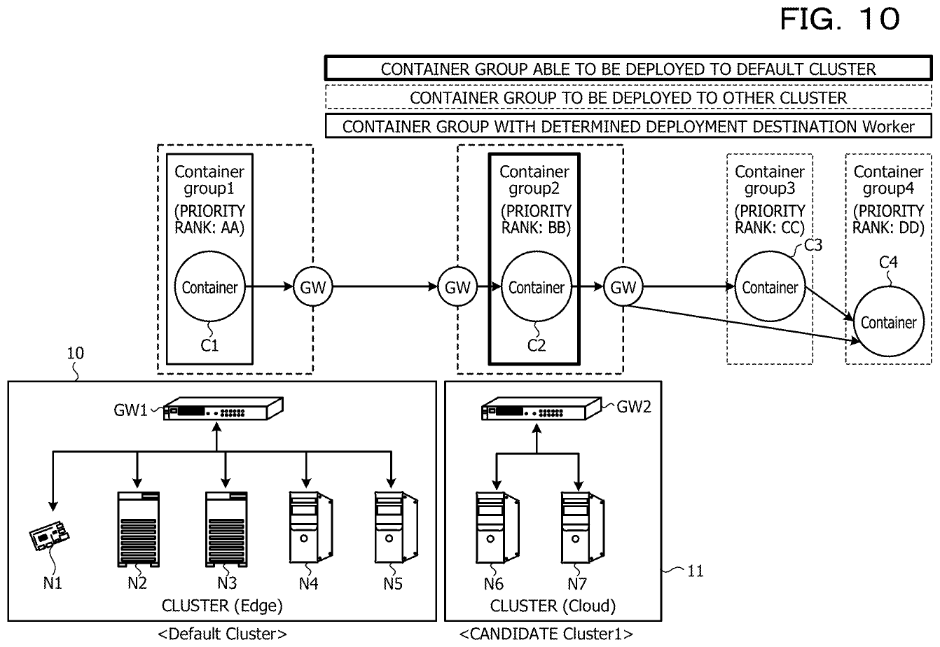

FIGS. 9 and 10 are explanatory diagrams exemplifying a search for the deployment destination to the other cluster. As illustrated in FIG. 9, the resource allocation apparatus according to the embodiments searches the deployment destinations of the containers C1 to C4 in the cluster (Edge) 10 that is the default cluster assigned with the highest cluster priority. In a case where only the container C1 is able to be deployed, for the containers C2 to C4, the resource allocation apparatus according to the embodiments searches the deployment destinations in other clusters than the cluster (Edge) 10 in descending order of the cluster priority.

For example, as illustrated in FIG. 10, the resource allocation apparatus according to the embodiments searches the deployment destinations of the containers C2 to C4 in the cluster (Cloud) 11 that is the cluster assigned with the next highest cluster priority after the cluster (Edge) 10. In a case where only the container C2 is able to be deployed here, for the containers C3 to C4, the resource allocation apparatus according to the embodiments searches the deployment destinations in other clusters than the cluster (Edge) 10 or the cluster (Cloud) 11 in descending order of the cluster priority.

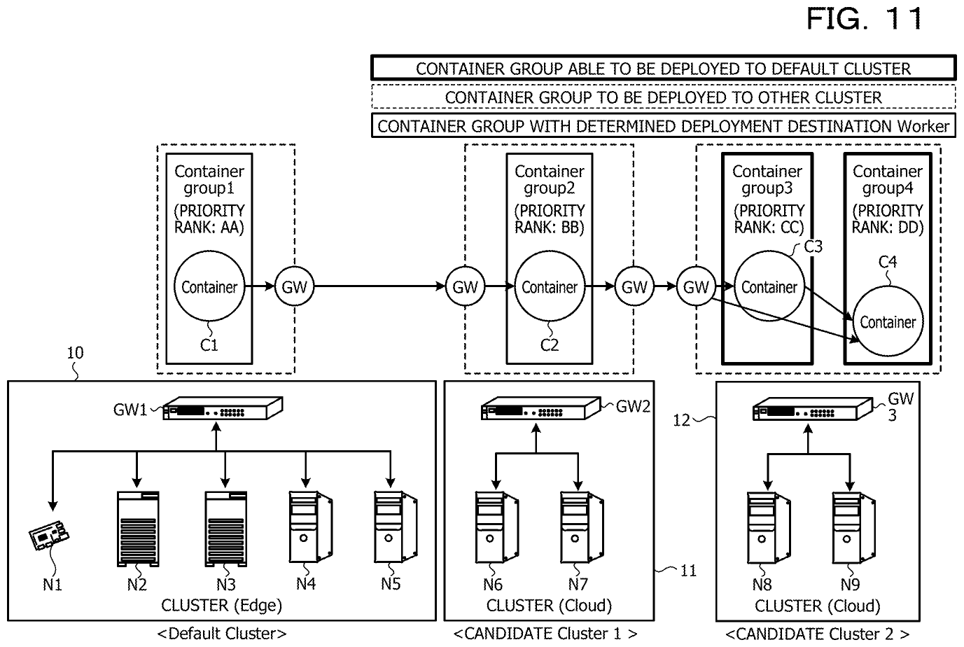

FIG. 11 is an explanatory diagram exemplifying the determination of the deployment destination of the container. As illustrated in FIG. 11, the resource allocation apparatus according to the embodiments searches the deployment destinations of the containers C3 to C4 in a cluster (Cloud) 12 that is the cluster assigned with the next highest cluster priority after the cluster (Cloud) 11. Since the containers C3 to C4 are able to be deployed to the cluster (Cloud) 12, the resource allocation apparatus according to the embodiments determines the deployment destinations of all the containers C1 to C4.

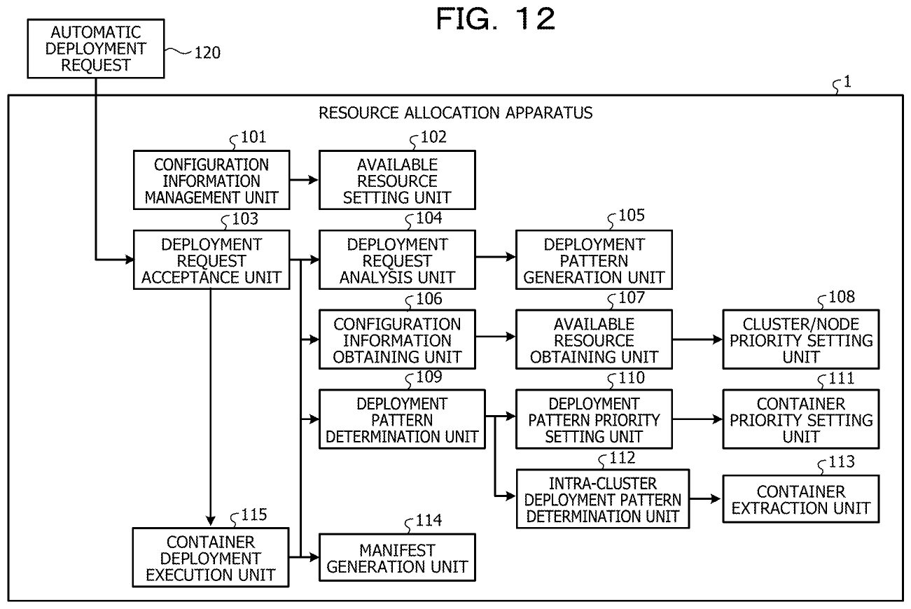

FIG. 12 is a block diagram explaining an example of the functional configurations of the resource allocation apparatus according to the embodiments. As illustrated in FIG. 12, a resource allocation apparatus 1 includes a configuration information management unit 101, an available resource setting unit 102, a deployment request acceptance unit 103, a deployment request analysis unit 104, a deployment pattern generation unit 105, a configuration information obtaining unit 106, an available resource obtaining unit 107, and a cluster/node priority setting unit 108. The resource allocation apparatus 1 also includes a deployment pattern determination unit 109, a deployment pattern priority setting unit 110, a container priority setting unit 111, an intra-cluster deployment pattern determination unit 112, a container extraction unit 113, a manifest generation unit 114, and a container deployment execution unit 115.

The configuration information management unit 101 is a processing unit that stores and manages, in a storage device such as a memory or a hard disk drive (HDD), configuration information (for example, the system information 300) such as resources related to the deployment destinations of the containers.

The available resource setting unit 102 is a processing unit that sets information on available resources (for example, the system information 300 and the like) based on operation input from the user via a GUI and the like. The available resource setting unit 102 sets the information such as the system information 300 input by the user in the configuration information management unit 101.

The deployment request acceptance unit 103 is a processing unit that accepts an automatic deployment request 120 to the resource (individual node). For example, the deployment request acceptance unit 103 accepts the automatic deployment request 120 including the application template 301 and the like for deploying the programs included in the process on a container-by-container basis.

The deployment request analysis unit 104 is a processing unit that analyzes the automatic deployment request 120 accepted by the deployment request acceptance unit 103. For example, the deployment request analysis unit 104 extracts information such as the container information 311 and the flow information 312 from the application template 301 included in the automatic deployment request 120.

The deployment pattern generation unit 105 is a processing unit that generates the deployment pattern of the containers based on the automatic deployment request 120. For example, the deployment pattern generation unit 105 generates a plurality of the deployment patterns for the containers from the application template 301 included in the automatic deployment request 120. For example, in a case of deployment of the containers C1 to C4, the deployment pattern generation unit 105 generates, by changing the combinations, a plurality of the deployment patterns such as a deployment pattern in which the containers C1 to C4 are separately deployed and a deployment pattern in which a plurality of the containers C1 to C4 are combined.

In a case where not all the containers are able to be deployed to the nodes of the default cluster (for example, the nodes N1 to N5 of the cluster (Edge) 10) with the generated deployment patterns, the deployment pattern generation unit 105 generates a deployment pattern by selecting the candidate containers to be deployed to the nodes of the other cluster (for example, the nodes N6 to N7 of the cluster (Cloud) 11).

The configuration information obtaining unit 106 obtains the configuration information managed by the configuration information management unit 101. The available resource obtaining unit 107 obtains the information on the available resources (the nodes included in each cluster) from the configuration information (for example, the system information 300 or the like) obtained by the configuration information obtaining unit 106.

The cluster/node priority setting unit 108 is a processing unit that sets the priority for each cluster and each node (cluster priority, node priority). For example, the cluster/node priority setting unit 108 sets the cluster priority for each cluster in the available resource obtained by the configuration information obtaining unit 106 based on operation input from the user via the GUI or the like. Similarly, the cluster/node priority setting unit 108 sets the node priority for each node in the available resource based on operation input from the user.

The deployment pattern determination unit 109 is a processing unit that determines, as a pattern with which container allocation is executed, a deployment pattern satisfying the resource requisite from among the deployment patterns generated by the deployment pattern generation unit 105.

For example, the deployment pattern determination unit 109 determines whether the resource of the deployment destination indicated by the system information 300 satisfies the requisite of the resource in each container indicated by the application template 301 in order of the priority set for the deployment patterns generated by the deployment pattern generation unit 105.

For the deployment pattern in which a cluster (for example, the cluster (Cloud) 11) different from a specific cluster (for example, the cluster (Edge) 10) is set as the candidate for the deployment destination, the deployment pattern determination unit 109 assumes that the container for which the other cluster is selected as the deployment destination is deployed to the gateway of the specific cluster. Next, based on the flow information 312 related to communication between the containers, the deployment pattern determination unit 109 determines whether the communication band in the case where the deployment to the gateway is assumed satisfies the traffic of the candidate container to be deployed to the node of the specific cluster.

Next, in accordance with the above-described determination, the deployment pattern determination unit 109 determines as a pattern that allows execution of the container allocation of the deployment pattern determined to be a deployment pattern in which all the containers are able to be deployed.

The deployment pattern priority setting unit 110 is a processing unit that sets, based on the application template 301, the priority for each of the deployment patterns generated by the deployment pattern generation unit 105. For example, for each of the deployment patterns, the deployment pattern priority setting unit 110 sets the priority in order (for example, ascending order) of the amount of communication between the containers.

The container priority setting unit 111 is a processing unit that sets, based on the system information 300, the node priority for each of the nodes included in each cluster. For example, the container priority setting unit 111 sets the node priority in order of the resource amount (for example, ascending order) corresponding to the throughput of the CPU, the memory capacity, or the like in the node.

The intra-cluster deployment pattern determination unit 112 is a processing unit that determines an intra-cluster deployment pattern indicating to which node the container is allocated in the cluster. For example, for the deployment pattern searched by the deployment pattern determination unit 109, the intra-cluster deployment pattern determination unit 112 allocates the containers in order of the node priority set by the container priority setting unit 111 from among the nodes in each cluster indicated in the system information 300.

The container extraction unit 113 is a processing unit that extracts, from the application template 301, the container information 311 on the containers to be deployed in the cluster. The manifest generation unit 114 is a processing unit that generates a manifest file based on the deployment pattern determined by the deployment pattern determination unit 109 and the intra-cluster deployment pattern determination unit 112. The container deployment execution unit 115 is a processing unit that executes the deployment of the containers to the individual resources (for example, nodes N1 to N7, or the like) based on the manifest file generated by the manifest generation unit 114.

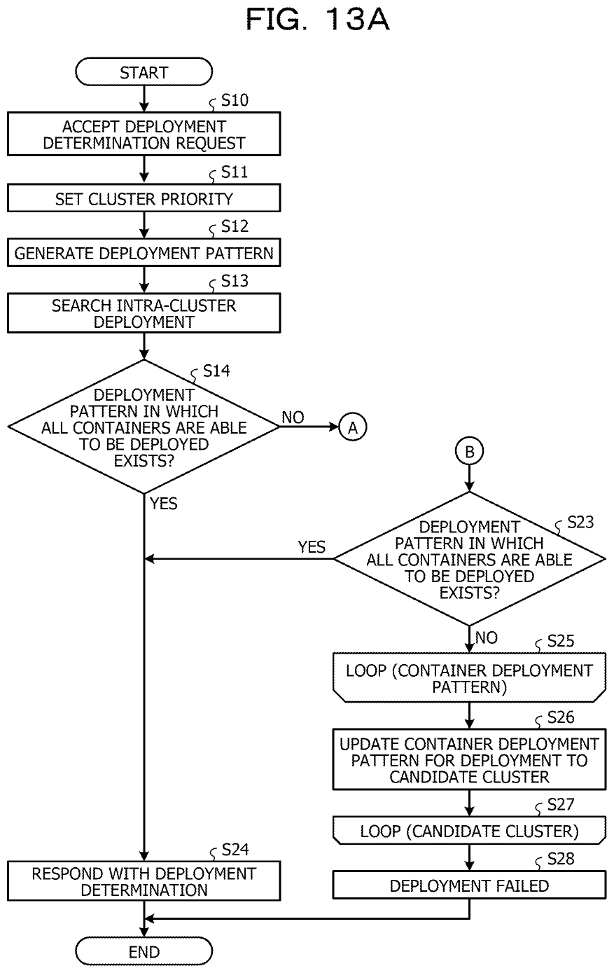

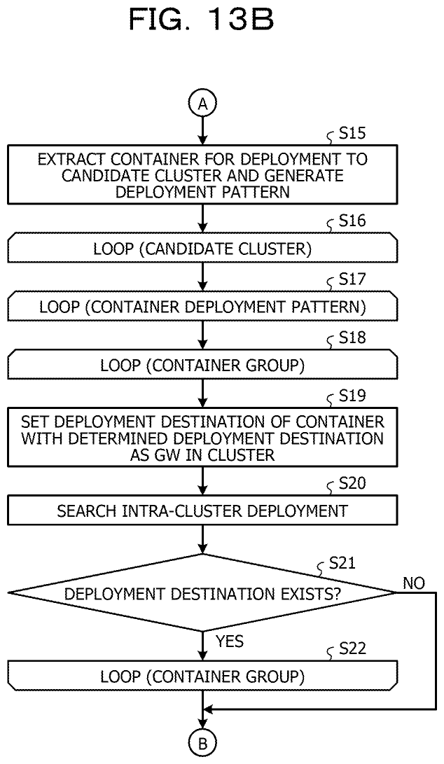

Next, the details of operation of the resource allocation apparatus 1 in a case where the automatic deployment request 120 is accepted will be described. FIGS. 13A and 13B are flowcharts illustrating an example of operation of the resource allocation apparatus 1 according to the embodiments.

As illustrated in FIGS. 13A and 13B, when processing starts, the deployment request acceptance unit 103 accepts the automatic deployment request 120 from a terminal device such as a PC (S10). Next, the cluster/node priority setting unit 108 sets the cluster priority based on operation input from the user via the GUI or the like (S11).

Next, for the cluster assigned with the highest cluster priority (default cluster), the deployment pattern generation unit 105 generates the deployment pattern of the containers based on the automatic deployment request 120 (S12). Next, the deployment pattern determination unit 109 determines whether the resource requisite is satisfied in a case where the container is deployed to the node in the default cluster for which the deployment pattern is generated and searches whether all the containers are able to be deployed to the cluster (S13).

Next, the deployment pattern determination unit 109 determines whether a deployment pattern in which all the containers are able to be deployed to the default cluster exists (S14). In a case where such a deployment pattern exists (S14: Yes), the deployment pattern determination unit 109 determines deployment execution in the deployment pattern in which the deployment is allowed and responds to the manifest generation unit 114 with the determined deployment pattern (S24). The manifest generation unit 114 generates the manifest based on the determined deployment pattern. Based on the manifest generated by the manifest generation unit 114, the container deployment execution unit 115 deploys the containers to the nodes.

In a case where the deployment pattern in which all the containers are able to be deployed to the default cluster does not exist (S14: No), the deployment pattern generation unit 105 extracts candidate containers to be deployed to the nodes of the other cluster (for example, the nodes N6 to N7 of the cluster (Cloud) 11). For example, the deployment pattern generation unit 105 extracts the containers by arbitrarily changing the quantity and combination of the containers to be deployed to the other cluster and extracts the containers. Next, the deployment pattern generation unit 105 sets the candidate destination cluster by selection in descending order of the cluster priority and generates the deployment pattern in which the extracted containers are deployed to the cluster (S15).

Next, the deployment pattern determination unit 109 performs a loop process (S16 to S27) as many times as the number of the generated candidate clusters. For example, the deployment pattern determination unit 109 first performs a loop process (S17 to S25) for each container deployment pattern.

When the loop process (S17 to S25) on a container deployment pattern-by-container deployment pattern basis starts, the deployment pattern determination unit 109 performs a loop process (S18 to S22) related to the container group.

For example, the deployment pattern determination unit 109 sets the deployment destination of the container with the determined deployment destination in the default cluster as the gateway (GW) in the cluster (S19). Next, as is the case with S13, the deployment pattern determination unit 109 searches whether all the containers are able to be deployed to the cluster (S20).

Next, the deployment pattern determination unit 109 determines whether the deployment destination exists (S21). In the case where the deployment destination (S21: Yes) exists, the deployment pattern determination unit 109 continues the loop process. In the case where the deployment destination does not exist (S21: No), the deployment pattern determination unit 109 exits from the loop process (S18 to S22) related to the container group.

Next, the deployment pattern determination unit 109 determines whether a deployment pattern in which all the containers are able to be deployed exists (S23). In the case where the deployment pattern in which all the containers are able to be deployed exists (S23: Yes), the deployment pattern determination unit 109 exits the loop process (S16 to S27) and causes the processing to proceed to S24. In the case where the deployment pattern in which all the containers are able to be deployed does not exist (S23: No), the deployment pattern determination unit 109 continues the loop process (S16 to S27).

After the loop process (S17 to S25) on a container deployment pattern-by-container deployment pattern has been performed, the deployment pattern determination unit 109 updates the container deployment pattern for the deployment to the candidate cluster (S26) and returns the processing to the beginning of the loop (S16).

In a case where the loop process ends without finding a deployment pattern in which all the containers are able to be deployed in the loop process (S16 to S27) performed as many times as the number of the generated candidate clusters, the deployment pattern determination unit 109 determines that the container is unable to be deployed and the deployment of the containers has failed (S28) and ends the processing.

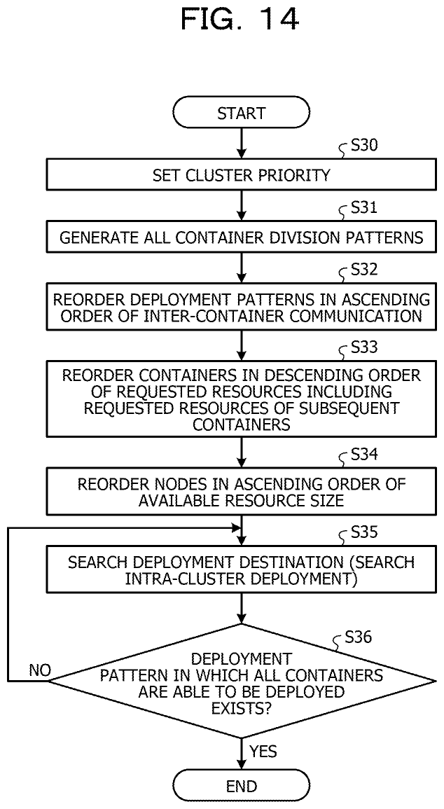

FIG. 14 is a flowchart illustrating an example of operation of deployment pattern generation and intra-cluster deployment search. For example, the flowchart of FIG. 14 illustrates an example of detailed operation of S11 to S14 described above.

As illustrated in FIG. 14, the cluster/node priority setting unit 108 sets the cluster priority based on the operation input from the user (S30). Next, for the cluster for which the highest cluster priority has been set (default cluster), the deployment pattern generation unit 105 generates all the patterns of the container deployment based on the automatic deployment request 120 (S31).

Next, based on the flow information 312, the deployment pattern generation unit 105 reorders the generated deployment patterns in ascending order of the inter-container communication (S32).

Next, the deployment pattern generation unit 105 reorders the containers of each deployment pattern in descending order of requested resources including the requested resources of the subsequent containers which are subsequent in the coupling relationship between the containers (S33). Next, based on the system information 300, the deployment pattern generation unit 105 reorders the nodes in ascending order of the available resource size (for example, the throughput of the CPU, the memory capacity, or the like) (S34).

Next, the deployment pattern determination unit 109 refers to the deployment patterns and the nodes having been reordered in S32 to S34 to search the deployment destinations of the containers that satisfy the resource requisite (intra-cluster deployment search) (S35). Next, the deployment pattern determination unit 109 determines whether the deployment pattern in which all the containers are able to be deployed exists (S36). In the case where such a deployment pattern exists (S36: Yes), the deployment pattern determination unit 109 ends the processing. In the case where such a deployment pattern does not exist (S36: No), the deployment pattern determination unit 109 returns the processing to S35.

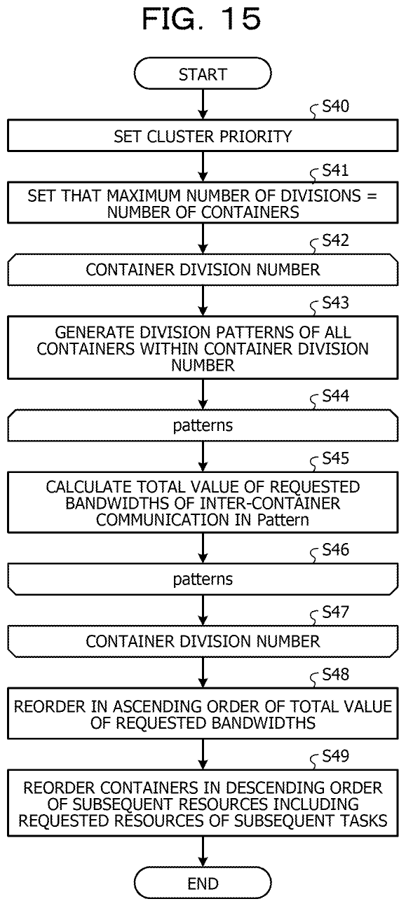

FIG. 15 is a flowchart illustrating an example of operation of reordering of the deployment patterns. For example, the flowchart of FIG. 15 illustrates an example of detailed operation of S30 to S33 described above.

As illustrated in FIG. 15, the deployment pattern generation unit 105 sets cluster priority (S40) and sets that the maximum number of divisions=the number of containers (S41). Next, the deployment pattern generation unit 105 performs the loop process (S42 to S47) as many times as the number of divisions of the containers.

For example, the deployment pattern generation unit 105 generates the deployment patterns of all the containers within the number of divisions of the containers (S43). Next, for each of the generated patterns (patterns), the deployment pattern generation unit 105 calculates a total value of requested bandwidths of the inter-container communication in the pattern based on the flow information 312 (S44 to S46).

After the loop process (S42 to S47) has been performed as many times as the number of the divisions of the containers, the deployment pattern generation unit 105 reorders the deployment patterns in ascending order of the total value of the requested bandwidths (S48). Next, the deployment pattern generation unit 105 reorders the containers of each deployment pattern in descending order of the subsequent requested resources including the requested resources of the subsequent containers (S49) and ends the processing related to the reordering.

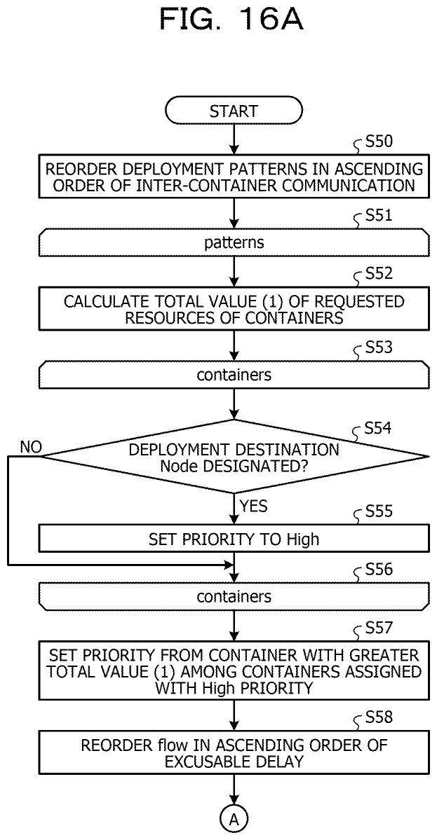

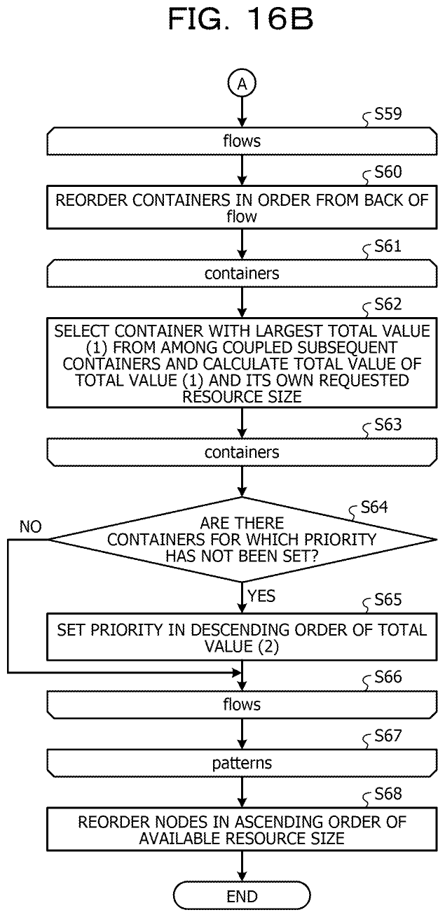

FIGS. 16A and 16B are flowcharts illustrating an example of operation of reordering of the containers. For example, the flowcharts of FIGS. 16A and 16B illustrate an example of detailed operation related to S49 described above.

As illustrated in FIGS. 16A and 16B, when the processing starts, based on the flow information 312, the deployment pattern generation unit 105 reorders the deployment patterns in ascending order of the inter-container communication (S50). Next, the deployment pattern generation unit 105 performs the loop process (S51 to S67) for each of the deployment patterns (patterns).

For example, the deployment pattern generation unit 105 calculates a total value (1) of the requested resources of the containers. This total value (1) may be, for example, a resource item-by-resource item value such as the CPU throughput, the network resource, or the memory capacity.

Next, the deployment pattern generation unit 105 performs the loop process (S53 to S56) for each of the containers (containers). For example, the deployment pattern generation unit 105 determines whether the deployment destination node (Node) is designated for each container (S54). In a case where the deployment destination node is designated (S54: Yes), the deployment pattern generation unit 105 sets the priority of this container to High (S55). In a case where the deployment destination node is not designated (S54: No), the deployment pattern generation unit 105 skips the processing in S55.

Next, the deployment pattern generation unit 105 sets the priorities such that, among the containers assigned with the High priority, as the total value (1) of the container becomes larger, the priority becomes higher (S57). Next, the deployment pattern generation unit 105 orders the communication flows (flow) indicated in the flow information 312 in ascending order of excusable delay (S58).

Next, the deployment pattern generation unit 105 performs the loop process (S59 to S66) for each of the flows having been reordered. For example, the deployment pattern generation unit 105 reorders the containers in order from the back of the flow (S60).

Next, the deployment pattern generation unit 105 performs the loop process (S61 to S63) for each of the containers (containers). For example, the deployment pattern generation unit 105 selects the container with the largest total value (1) from among the subsequent containers coupled to the container subjected to the loop process and calculates a total value (2) of the largest total value (1) and its own requested resource size (S62).

Next, the deployment pattern generation unit 105 determines whether there are containers for which the priority has not been set (S64). In a case where there are containers for which the priority has not been set, the deployment pattern generation unit 105 sets the priority of the containers in descending order of the total value (2) for the containers for which the priority has not been set (S65). In a case where there is not a container for which the priority has not been set (S64: No), the deployment pattern generation unit 105 skips the processing in S65.

After the loop process (S51 to S67), the deployment pattern generation unit 105 reorders the nodes in ascending order of the available resource size indicated by the system information 300 (S68) and ends the processing.

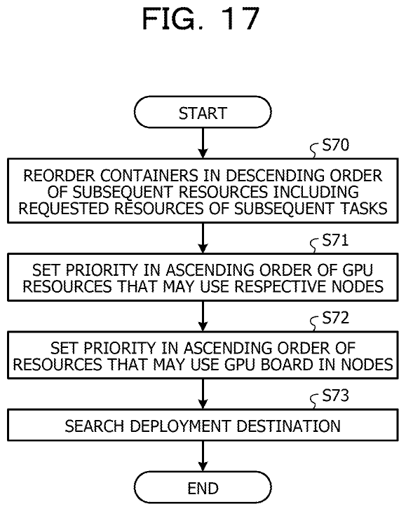

FIG. 17 is a flowchart illustrating an example of operation of reordering of the nodes. For example, the flowchart of FIG. 17 illustrates an example of detailed operation related to, for example, S34 described above.

As illustrated in FIG. 17, when the processing starts, the deployment pattern generation unit 105 reorders the containers in descending order of the requested resources including the requested resources of the subsequent tasks (subsequent containers) based on the application template 301 (S70). Next, based on the system information 300, the deployment pattern generation unit 105 sets the priority of the containers in ascending order of GPU resources that may use the respective nodes (S71).

Next, the deployment pattern generation unit 105 sets the priority of the nodes in ascending order of the resources (nodes) that may use the GPU boards in the nodes (S72). Next, the deployment pattern determination unit 109 searches the deployment destination in order of the set priority (S73) and ends the processing.

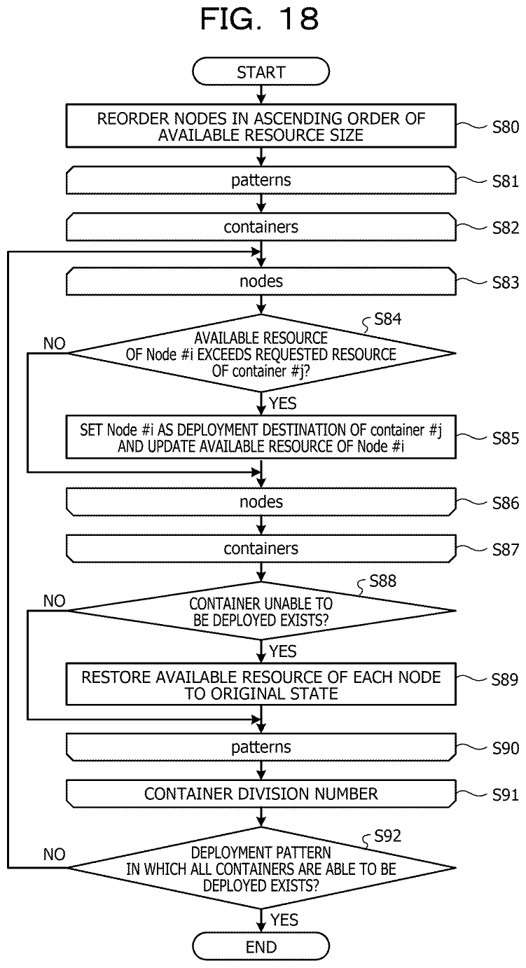

FIG. 18 is a flowchart illustrating an example of operation of the deployment destination search. As illustrated in FIG. 18, when the processing starts, the deployment pattern determination unit 109 reorders the nodes in ascending order of the available resource size based on the system information 300 (S80).

Next, the deployment pattern determination unit 109 performs a loop process (S81 to S90) for each of the deployment patterns generated by the deployment pattern generation unit 105. For example, the deployment pattern determination unit 109 performs a loop process (S82 to S87) for each container included in the deployment patterns.

When the loop process (S82 to S87) for the containers starts, the deployment pattern determination unit 109 performs a loop process (S83 to S86) with respect to each node (Node). In this loop process (S83 to S86), the deployment pattern determination unit 109 determines whether the available resource of the node to be processed (Node #i) exceeds the requested resource of the container to be processed (container #j) (S84).

In a case where the available resource exceeds the requested resource (S84: Yes), the deployment pattern determination unit 109 sets Node #i as the deployment destination of container #j and updates the available resource of Node #i (S85). For example, the deployment pattern determination unit 109 updates the available resource by subtracting the requested resource of the container #j from the available resource of the Node #i. In a case where the available resource does not exceed the requested resource (S84: No), the deployment pattern determination unit 109 skips the processing in S85.

After the loop process (S82 to S87) for the containers, the deployment pattern determination unit 109 determines whether a container unable to be deployed exists (S88). In a case where such a container exists (S88: Yes), the deployment pattern determination unit 109 undoes the update, in S85, of the available resource of each node and restores the original state (S89).

Next, the deployment pattern determination unit 109 executes the loop process (S81 to S90) for the deployment patterns on a deployment pattern-by-deployment pattern basis as many times as the number of divisions of the containers (S91) to determine whether the deployment pattern in which all the containers are able to be deployed exists (S92). In the case where such a deployment pattern does not exist (S92: No), the deployment pattern determination unit 109 returns the processing to S83. In the case where such a deployment pattern exists (S92: Yes), the deployment pattern determination unit 109 determines that the deployment pattern in which all the containers are able to be deployed is used to deploy the containers and ends the processing.

For the deployment patterns generated by the deployment pattern generation unit 105, the deployment pattern priority setting unit 110 may set the priority (container deployment pattern priority). Thus, the deployment pattern determination unit 109 searches the candidates in descending order of the container deployment pattern priority set by the deployment pattern priority setting unit 110.

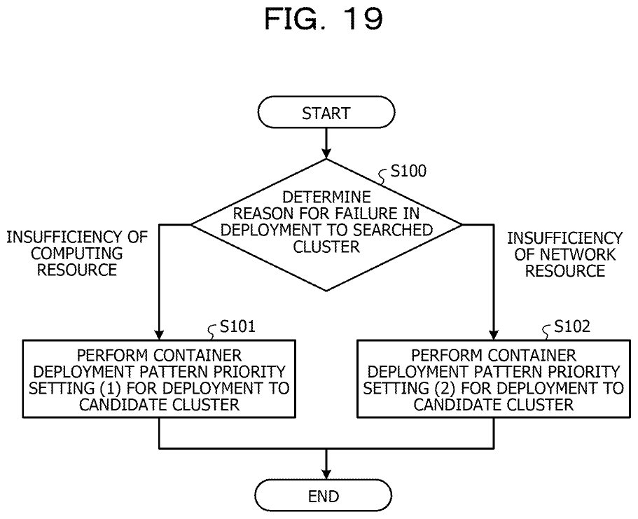

FIG. 19 is a flowchart illustrating an example of operation of container deployment pattern priority setting. As illustrated in FIG. 19, when the processing starts, the deployment pattern priority setting unit 110 determines a reason for a failure in the deployment to the cluster searched by the deployment pattern determination unit 109 in, for example, the previous processing (S100).

In a case where the reason for the failure is the insufficiency of the computing resource, the deployment pattern priority setting unit 110 performs container deployment pattern priority setting (1) for the deployment to the candidate cluster (S101).

In a case where the reason for the failure is the insufficient network resource, the deployment pattern priority setting unit 110 performs container deployment pattern priority setting (2) for the deployment to the candidate cluster (S102).

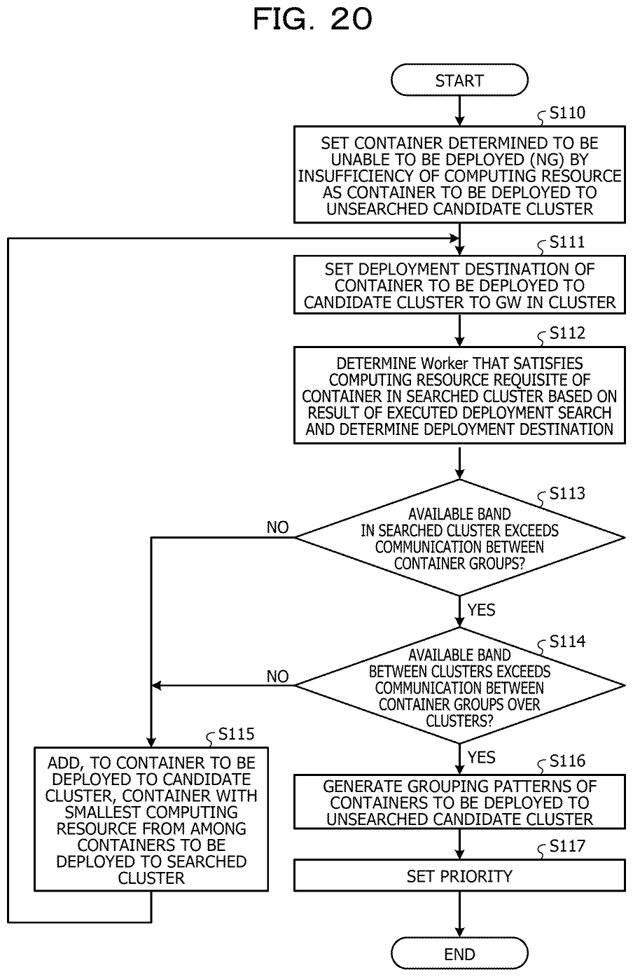

FIG. 20 is a flowchart illustrating an example of operation of the container deployment pattern priority setting (1). As illustrated in FIG. 20, when the container deployment pattern priority setting (1) starts, the deployment pattern priority setting unit 110 sets the container determined to be unable to be deployed (NG) by the insufficiency of the computing resource as the container to be deployed to an unsearched candidate cluster (S110).

Next, the deployment pattern determination unit 109 sets the deployment destination of the container to be deployed to the candidate cluster to the gateway (GW) in the cluster (S111). Next, based on a result of the deployment search having been executed, the deployment pattern determination unit 109 determines the Worker (node) that satisfies the computing resource requisite of the container in the searched cluster and determines the deployment destination of the container (S112).

Next, based on the system information 300 and the application template 301, the deployment pattern determination unit 109 determines whether an available communication band in the searched cluster exceeds (satisfies) the communication (traffic) between the container groups (S113).

In a case where the communication (traffic) is satisfied (S113: Yes), the deployment pattern determination unit 109 determines whether the available communication band between the clusters exceeds (satisfies) the communication (traffic) between the container groups over the clusters (S114).

In a case where the communication (traffic) is not satisfied in S113 or S114 (S113: No, S114: No), the deployment pattern determination unit 109 adds, to the container to be deployed to the candidate cluster, the container with the smallest computing resource from among the containers to be deployed to the searched cluster (S115) and returns the processing to S111.

In a case where the communication (traffic) is satisfied in S114 (S114: Yes), the deployment pattern determination unit 109 generates grouping patterns of the containers to be deployed to the unsearched candidate cluster (S116). Next, the deployment pattern priority setting unit 110 sets the priority for the generated grouping patterns similarly to the above-described manner (S117) and ends the processing.

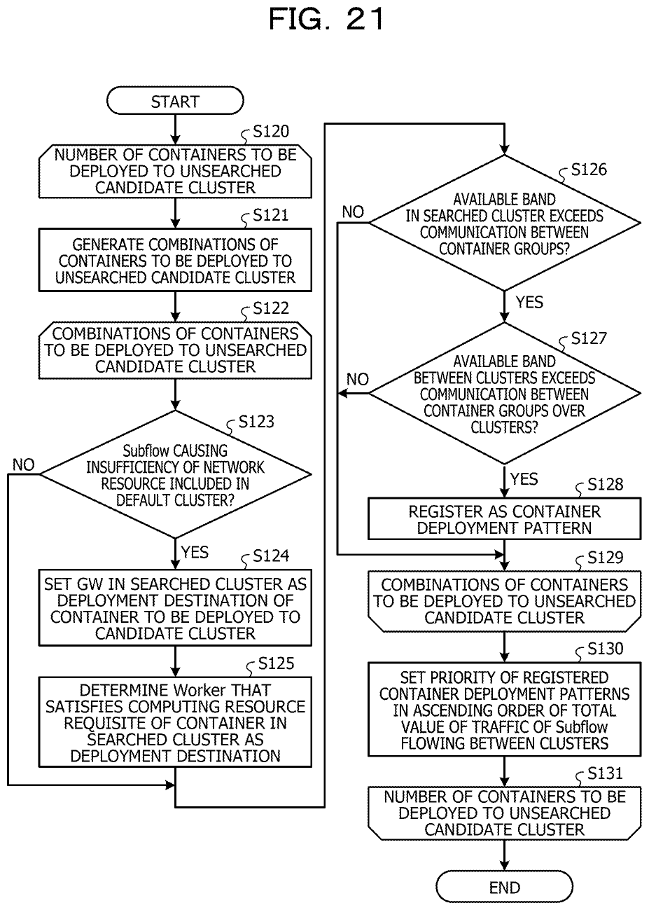

FIG. 21 is a flowchart illustrating an example of operation of the container deployment pattern priority setting (2). When the processing starts, the deployment pattern determination unit 109 performs a loop process as many times as the number of containers to be deployed to the unsearched candidate cluster (S120 to S131).

For example, the deployment pattern determination unit 109 generates the combinations of containers to be deployed to the unsearched candidate cluster (S121). Next, the deployment pattern determination unit 109 performs a loop process (S122 to S129) as many times as the number of the generated combinations.

For example, the deployment pattern determination unit 109 determines whether the subflow causing the insufficiency of the network resource is included in the default cluster (S123). In a case where the subflow causing the insufficiency of the network resource is not included in the default cluster (S123: No), the deployment pattern determination unit 109 causes the processing to proceed to S126.

In a case where the subflow causing the insufficiency of the network resource is included in the default cluster (S123: Yes), the deployment pattern determination unit 109 sets the gateway (GW) in the searched cluster as the deployment destinations of the containers to be deployed to the candidate cluster (S124).

Next, the deployment pattern determination unit 109 determines the Worker (node) that satisfies the computing resource requisite of the container in the searched cluster as the deployment destination of the container (S125).

Based on the system information 300 and the application template 301, the deployment pattern determination unit 109 determines whether the available communication band in the searched cluster exceeds (satisfies) the communication (traffic) between the container groups (S126).

In a case where the communication (traffic) is satisfied (S126: Yes), the deployment pattern determination unit 109 determines whether the available communication band between the clusters exceeds (satisfies) the communication (traffic) between the container groups extending over the clusters (S127).

In a case where the communication (traffic) is not satisfied in S126 or S127 (S126: No, S127: No), the deployment pattern determination unit 109 skips S128 and causes the processing to proceed to S129.

In a case where the communication (traffic) is satisfied in S127 (S127: Yes), the deployment pattern determination unit 109 registers the combination of the containers to be processed as the container deployment pattern (S128).

After the loop process (S122 to S129) has been performed as many times as the number of the generated combinations, for the registered container deployment pattern, based on the flow information 312, the deployment pattern priority setting unit 110 obtains a total value of the traffic of the subflow flowing between the clusters. Next, the deployment pattern priority setting unit 110 sets the priority of the container deployment pattern in ascending order of the obtained total value of the traffic (S130).

As described above, the resource allocation apparatus 1 is a resource allocation apparatus that deploys a process to each of the nodes N1 to N7 on a container-by-container basis. Based on the template information on each of the containers (C1 to C4) to be deployed, the resource allocation apparatus 1 selects candidate containers, from among the containers, to be deployed to the nodes N6 to N7 of the second cluster (11) that is coupled to the first cluster (10) via the external network 13. Based on the flow information on the communication between containers, the resource allocation apparatus 1 determines whether the communication band in a case where the deployment destination of the selected container is the gateway (GW1) of the first cluster coupled to the external network 13 satisfies the traffic of the candidate containers to be deployed to the nodes of the first cluster. Based on this determination result, the resource allocation apparatus 1 determines the deployment destination of each container.

At the time of the deployment pattern search for searching an information processing apparatus (node) to which the container is to be deployed, with respect to the container the deployment destination of which is the second cluster, the resource allocation apparatus 1 performs replacement with the deployment pattern search in the first cluster by using the above-described determination on the communication band. Thus, with the resource allocation apparatus 1, since the number of the nodes as deployment candidates is limited (independently of, for example, the number of nodes in the second cluster), an increase in the number of combinations of the nodes that are the deployment candidates may be suppressed even in a case where the containers are deployed over a plurality of clusters. In a case where the number of combinations of the nodes to be searched increases due to deployment over the plurality of clusters, man-hours regarding the resource allocation increase, and accordingly, it becomes difficult to find appropriate container allocation. However, the resource allocation apparatus 1 may suppress the increase in the number of combinations of the nodes that are the deployment candidates and may assist in allocating the resource over a plurality of clusters such that the resource allocation is facilitated.

In a case where not all the containers (C1 to C4) are able to be deployed to the nodes of the first cluster, the resource allocation apparatus 1 selects the candidate container to be deployed to the node of the second cluster. Thus, in a case where not all the containers are able to be deployed to the first cluster and are deployed over the first and the second clusters, the resource allocation apparatus 1 may select the container to be deployed.

The resource allocation apparatus 1 selects a plurality of container groups including one or a plurality of candidate containers to be deployed to the nodes of the second cluster. For each of the plurality of selected container groups, the resource allocation apparatus 1 determines whether the containers included in the container group satisfy the traffic on a container-by-container basis. Thus, the resource allocation apparatus 1 may search for the deployment destination for each of the plurality of container groups.

Based on the flow information, the resource allocation apparatus 1 reorders the plurality of selected container groups in ascending order of inter-container communication. The resource allocation apparatus 1 determines whether the containers included in the container groups satisfy the traffic on a container-by-container basis in order of the reordered container groups. Thus, the resource allocation apparatus 1 may search in ascending order of the inter-container communication when searching for the deployment destination of each container for each of the plurality of container groups. As described above, the resource allocation apparatus 1 may search sequentially from the container with less inter-container communication and a possibility of satisfying a resource condition related to the communication.

For each container included in the container group, the resource allocation apparatus 1 sets the container priority for the container based on a requested resource amount of the container based on the template information. The resource allocation apparatus 1 determines whether each of the containers included in the container groups satisfy the traffic on a container-by-container basis in order of the set container priority. Thus, when searching the deployment destination of each container included in the container group, the resource allocation apparatus 1 may search in order of the priority based on the requested resource amount of the container and, for example, may search in ascending order of the requested resource amount.

The resource allocation apparatus 1 identifies the second cluster from among the plurality of clusters based on the cluster priority set for each cluster. Thus, the resource allocation apparatus 1 may rank the clusters that are to be the candidates for the deployment destination from among the plurality of clusters.

Each element of each apparatus illustrated in the drawings is not necessarily physically configured as illustrated in the drawings. For example, the specific form of the distribution or integration of the apparatus is not limited to the illustrated form, and all or part of the apparatus may be configured in arbitrary units in a functionally or physically distributed or integrated manner depending on various loads, usage statuses, or the like.

All or an arbitrary subset of the various functional configurations (101 to 115) to be executed by the resource allocation apparatus 1 may be executed by a CPU (or a microcomputer such as a microprocessor unit (MPU) or a micro controller unit (MCU)). Of course, all or an arbitrary subset of the various functional configurations may be executed with a program analyzed and executed by a CPU (or a microcomputer such as an MPU or an MCU) or with hardware of wired logic. The various functional configurations to be executed by the resource allocation apparatus 1 may be executed by cloud computing in which a plurality of computers collaborate with each other.

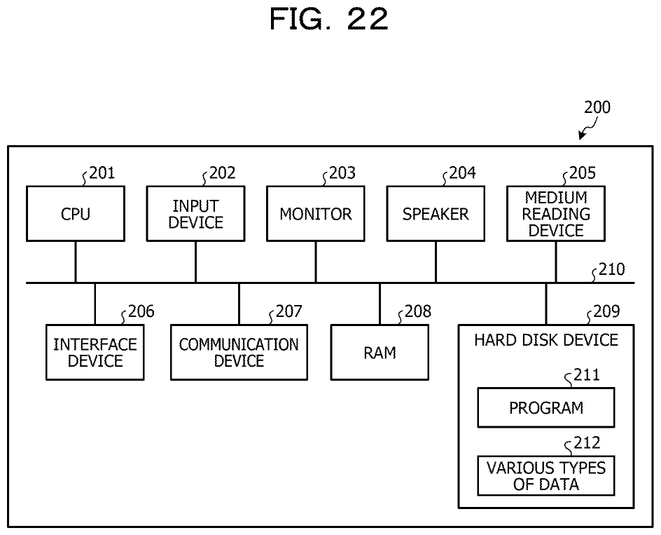

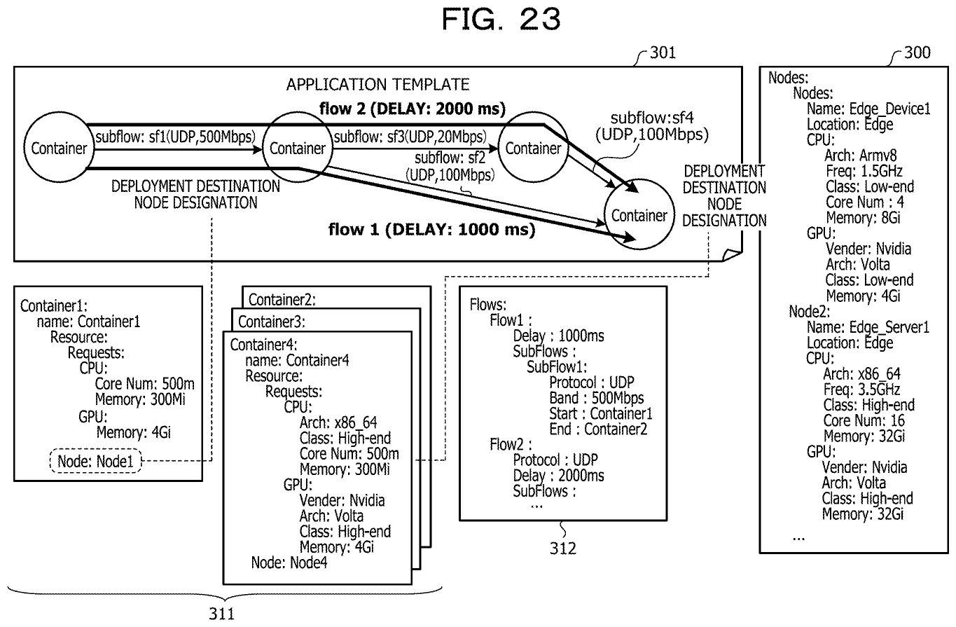

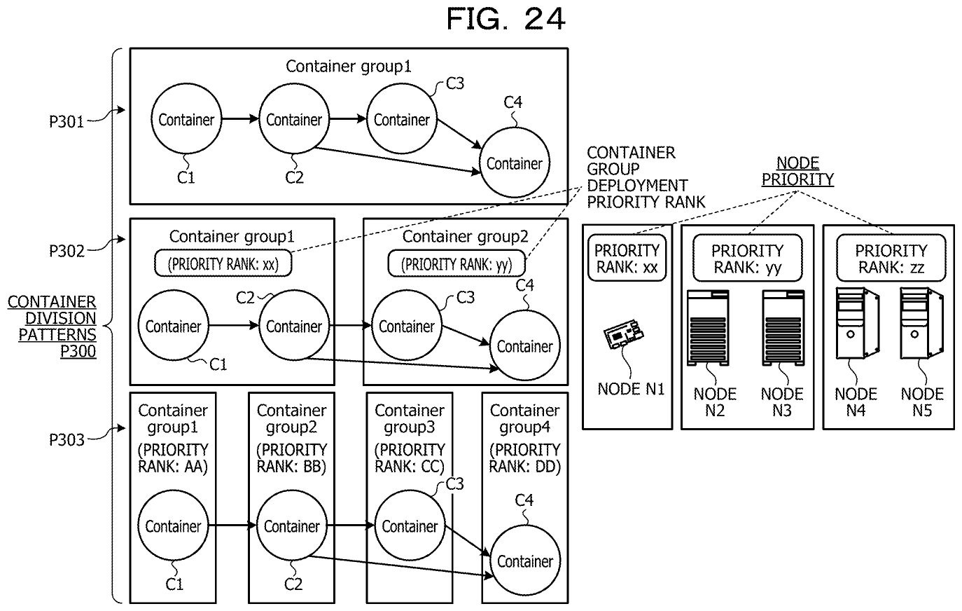

The processing in the various functional configurations (101 to 115) described according to the above-described embodiments may be realized by executing, with a computer, a program prepared in advance. Hereinafter, an example of the configuration of the computer (hardware) that executes the program having the functions similar to the functions of the above-described embodiments will be described. FIG. 22 is an explanatory diagram explaining an example of the configuration of the computer.

As illustrated in FIG. 22, a computer 200 includes a CPU 201 that executes various arithmetic processes, an input device 202 that accepts data input, a monitor 203, and a speaker 204. The computer 200 also includes a medium reading device 205 that reads the program and so forth from a storage medium, an interface device 206 for coupling to various devices, and a communication device 207 for coupling to and communicating with an external device in a wired or wireless manner. The computer 200 also includes a random-access memory (RAM) 208 that temporarily stores various types of information, and a hard disk device 209. The components (201 to 209) in the computer 200 are coupled to a bus 210.

The hard disk device 209 stores a program 211 for executing various processes in the functional configurations (101 to 115) described in the embodiments above. The hard disk device 209 also stores various types of data 212 to be referred to by the program 211. The input device 202 accepts, for example, input of operation information from the operator. The monitor 203 displays, for example, various screens to be operated by the operator. For example, a printer or the like is coupled to the interface device 206. The communication device 207 is coupled to a communication network such as a LAN and exchanges various types of information with the external device via the communication network.

The CPU 201 reads the program 211 stored in the hard disk device 209, loads the program 211 into the RAM 208, and executes the program 211, thereby performing various processes related to the above-described functional configurations (101 to 115). The program 211 is not necessarily stored in the hard disk device 209. For example, the program 211 stored in a storage medium readable by the computer 200 may be read and executed. For example, as the storage medium readable by the computer 200, a portable storage medium such as a compact disc read-only memory (CD-ROM), a Digital Versatile Disc (DVD), or a Universal Serial Bus (USB) memory, a semiconductor memory such as a flash memory, a hard disk drive, or the like is used. The program 211 may be stored in a device coupled to a public network, the Internet, a LAN, or the like, and the computer 200 may read and execute the program 211 from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A resource allocation apparatus comprising:
a memory; and
a processor coupled to the memory and configured to:
select, based on template information of each of a plurality of containers to be deployed, from among the containers, a first candidate container to be deployed to an information processing apparatus of a first cluster coupled to a second cluster via an external network,
determine, based on flow information of communication between the containers, whether a communication band in a case where the selected container is deployed to a gateway of the second cluster coupled to the external network satisfies traffic of a second candidate container to be deployed to an information processing apparatus of the second cluster, and
determine a deployment destination of each container, based on a result of the determination of whether the communication band satisfies the traffic.

2. The resource allocation apparatus according to claim 1, wherein the processor is configured to select the first candidate container in a case where not all the containers are able to be deployed to the information processing apparatuses of the second cluster.

3. The resource allocation apparatus according to claim 1,
wherein the processor is configured to
select a plurality of container groups including one or more first candidate containers to be deployed to the information processing apparatuses of the first cluster, and
determine whether the traffic is satisfied for each container included in a container group of the selected plurality of container groups.

4. The resource allocation apparatus according to claim 3,
wherein the processor is further configured to reorder the selected plurality of container groups in ascending order of inter-container communication, based on the flow information, and
wherein the processor is configured to determine whether the traffic is satisfied with respect to each container included in the container group, in order of the recorded container groups.

5. The resource allocation apparatus according to claim 3,
wherein the processor is further configured to, for each container included in the container group, set a container priority for the container, based on a requested resource amount of the container based on the template information, and
wherein the processor is configured to determine whether the traffic is satisfied in order of the set container priority with respect to each container included in the container group.

6. The resource allocation apparatus according to claim 1, wherein the processor is further configured to identify the first cluster from among a plurality of clusters, based on a cluster priority set for a cluster of the plurality of clusters.

7. A resource allocation method for causing a computer to execute a procedure, the procedure comprising:
selecting, based on template information of each of a plurality of containers to be deployed, from among the containers, a first candidate container to be deployed to an information processing apparatus of a first cluster coupled to a second cluster via an external network,
determining, based on flow information of communication between the containers, whether a communication band in a case where the selected container is deployed to a gateway of the second cluster coupled to the external network satisfies traffic of a second candidate container to be deployed to an information processing apparatus of the second cluster, and
determining a deployment destination of each container, based on a result of the determination of whether the communication band satisfies the traffic.

8. The resource allocation method according to claim 7, wherein the procedure selects the first candidate container in a case where not all the containers are able to be deployed to the information processing apparatuses of the second cluster.

9. The resource allocation method according to claim 7, wherein the procedure
selects a plurality of container groups including one or more first candidate containers to be deployed to the information processing apparatuses of the first cluster, and
determines whether the traffic is satisfied for each container included in a container group of the selected plurality of container groups.

10. The resource allocation method according to claim 9, the procedure further comprising:
reordering the selected plurality of container groups in ascending order of inter-container communication, based on the flow information,
wherein the procedure determines whether the traffic is satisfied with respect to each container included in the container group, in order of the recorded container groups.

11. The resource allocation method according to claim 9, wherein the procedure further comprising:
setting, for each container included in the container group, a container priority for the container, based on a requested resource amount of the container based on the template information,
wherein the procedure determines whether the traffic is satisfied in order of the set container priority with respect to each container included in the container group.

12. The resource allocation method according to claim 7, wherein the procedure further comprising:
identifying the first cluster from among a plurality of clusters, based on a cluster priority set for a cluster of the plurality of clusters.
